(19) United States
(12) Patent Application Publication
(10) Pub. No.: US 2002/0194939 A1
(43) Pub. Date: Dec. 26, 2002

(54) Inertial oscillator control system

(76) Inventor: James Edward Cox, Reno, NV (US)

Correspondence Address: James E Cox, P O Box 71151, Reno, NV, 89570, US

(21) Appl. No.: 09/886,714

(22) Filed: Jun. 20, 2001

(51) Int. Cl. F16H 27/04

(52) U.S. Cl. 74/84 S

(57) ABSTRACT

This invention relates to a mechanical oscillator control system yielding a force output for lifting a gravity payload. The oscillator system consists of an unbalanced inertial rotor or rotors constrained to orbit while undergoing strong radial motions. The rotor is rotateably connected to a moveable platform via a planetary gear orbiting about a fixed sun gear of equal size. The resulting oscillator generates strong coriolis forces that combine as compound forces with the centrifugal forces to generate a net alternating force on the platform. These forces are then coupled to a gravity payload via a mechanical clutch acting when the forces are upward, with platform re-positioning using a crank-spring mechanism. The load is lifted, and by gimbal vectoring, lateral motion is also achieved.

This application was originally filed as a provisional application on Jun. 22, 2000 and had an application No. 60/213,449.

### BACKGROUND

Various inventors have attempted to harness the forces of a rotating unbalanced mass in a mechanical oscillator. Dean, in his two patents U.S. Pat. Nos. 2,886,976 and 3,182,517 show counter-rotating masses in a carriage with forces transmitted to the frame by intermittent coupling of several kinds. In the first case, the patents use electromagnetic clutches acting on a tape attached to the load to be moved as well as solenoids to reposition the carriage. In the second case, rotating cams are used for both positioning and obstructing the pathway of the slide member. Output forces are obtained in each cycle of rotation, whereas in the case of Srogi, U.S. Pat. No. 4,242,918 the shuttle is retreived after 10 cycles using a rachet/pawl mechanism and return mechanism. Finally, in the case of Laul, U.S. Pat. No. 5,966,986, the unbalanced weights move into a guide channel which imparts the forces then the carriage plate moves back hitting the rear stop. All of the above devices use eccentric rotors having a fixed radius from their axles of rotation, and presummably the propulsion operates in any direction.

### THEORY OF OPERATION

Newton's Laws of Motion apply to any inertial frame of reference which is either stationary or moving at a uniform speed. In a rotating frame of reference, additional forces appear such as the coriolis force, due to radial motion of the mass and which acts perpendicular to the radius vector from the orbiting mass to the instant center of rotation. Centrifugal force acts outwardly as customarily occurs in uniform rotation about a fixed axis. If the rotation occurs with constant angular velocity (enforced by use of a flywheel), other forces such as angular accelerations and tangential accelerations can be ignored. Finally, radial accelerations are also neglected. Thus, the net force acting on the mass is the vector sum of just the centri centrifugal and coriolis forces. It has been found experimentally, that when a mechanical oscillator is designed such that the coriolis is of a magnitude comparable to the centrifugal forces, a non-newtonian phase angle arises causing an unbalanced force to momentarily arise, which accelerates the C.G. of the oscillator. Many studies of different coriolis inertial oscillators have confirmed this effect. The preferred embodiment shown herein is that of a planetary oscillator involving a satelite rotor orbiting about a planet gear, which in turn revolves about a fixed sun gear. Net forces acting on the moveable platform are just the sum of the coriolis and centrifugal forces. If the platform is then coupled to the frame and payload, with the direction of platform motion being vertical in the gravitational field of the planet, and said coupling occuring at a time increment when the platform is undergoing upward acceleration, a vertical thrust occurs that lifts the payload. The weight of the payload restricts the amplitude of oscillation of the platform, and its kinetic energy is converted into work on the payload (weight times the lift height). The motor restores the energy lost to the lifting of the payload via the flywheel and splined shaft/worm gear arrangement. After 90 degrees of rotation of the planet gear, the platform is decoupled and free to oscillate and free fall without affecting the frame and its load. The gravitational “weight” of the payload is one-directional (i.e.,always downward) in the frame, of the earth, and thus the restriction of the inertial oscillator is also one-directional yielding a one-directional lifting impulse on the payload. In the reverse direction, the oscillator is in free fall downward and thus no downward force acts on the payload from the action of the rotor.

### FIGURE DRAWINGS DESCRIPTION

FIG. 1. is a frontal view of the invention showing the planetary oscillator mounted on the moveable platform via rollers in a frame attached to a heavy payload. FIG. 1a. shows the trajectory of the satellite rotor mass.

FIG. 2. is a rear view the inertial oscillator control system with the clutch and repositioning controls as well as the splined drive shaft and slideable worm gear assembly with spring-crank positioning device. FIG. 2a shows an alternate method of driving the planetary rotor from a fixed motor using an Oldham coupler.

FIG. 3. shows a multiple unit arrange of planetary oscillators arranged vertically but in a frame which is gimbal mounted to the gravity payload and thus can be vectored off from the vertical to generate lateral thrust components.

### OBJECTIVES

The primary objective of this invention is to generate vertical lifting forces in the gravity field of the earth. The invention builds upon prior art in the use of rotating unbalanced masses. The inertial coriolis oscillator has the correct properties of being an alternating force generator, which, with the disclosed control system, has the capacity for high speed operation. At the same time, speed regulation must occur through appropriate sizing of a lightweight, high revolving speed flywheel via clutch assembly. At least two oscillator units are required, clocked 180 degrees appart to cancel transverse or lateral forces in a common rigid frame. Employment of a gravitational load with its asymmetrical properties (acting downward only) permits one-directional restriction of coriolis oscillator amplitude yielding vertical net impulses of thrust. Lastly, by gimbal mounting of the frame unit above the gravity payload, the frame can be vectored off from the vertical orientation to achieve horizonal motion of the gravity payload. Likewise, azimuthal rotation of this thrust vector permits directional control in the horizonal plane.

Detailed Description of Figures:

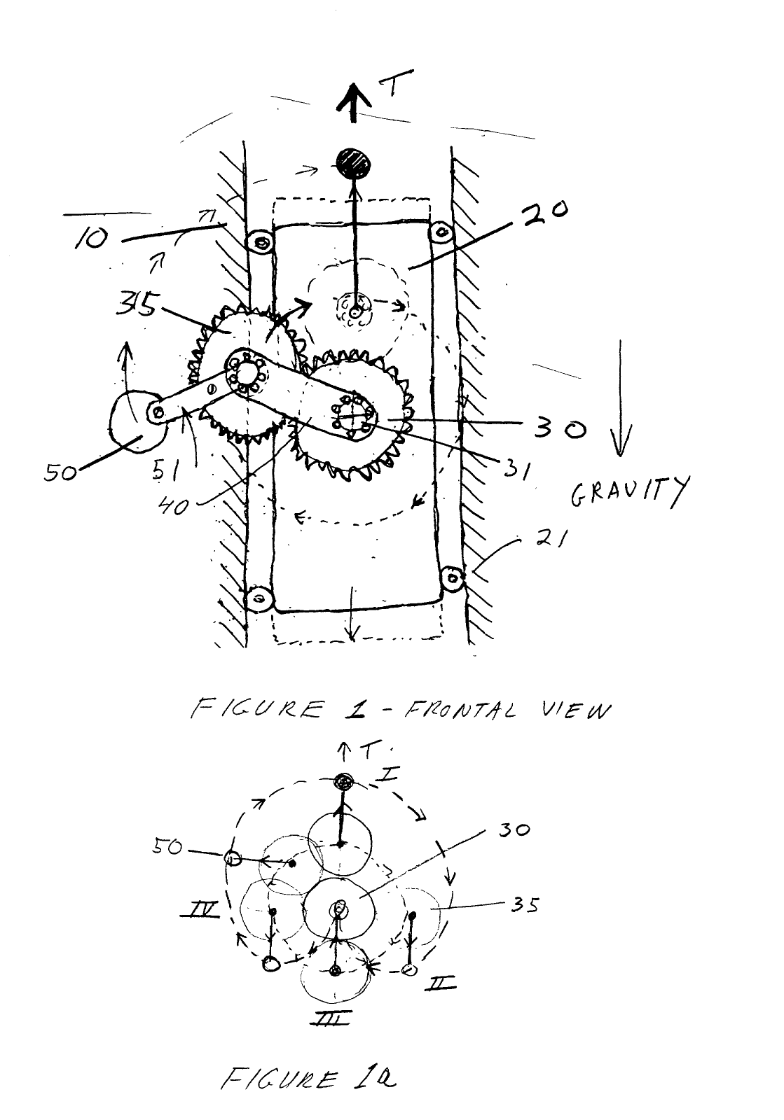

The generalized coriolis oscillator involves both radial motion of an orbiting mass with tangential velocities yielding compound forces on the mass. In the first embodiment shown in FIG. 1, a planetary gear arrangement is shown consisting of a fixed sun gear 30 attached to the moveable platform 20 free to oscillate vertical in gravity field of earth. The platform 20 is held rigidly in frame 10 via guide rollers or bearings 21. A planetary gear 35 revolves around the sun gear 30 via arm 40 and bearing assembly with axle 31 passing through the platform for drive connection. Unbalanced rotor 50 is connected to the planet gear 35 with arm 51. The entire assembly is then driven at constant anglular speed of the planet gear 35 about the sun gear 30. The rotor 50 tends to move at twice the speed of the planet gear 35. Generally, the spacing between the masses are made equal, but the rotor mass 50 can be made zero or very small as its effects due to its large radius and faster speed have strong effects on the platform motion. In FIG. 1a, as taught by Thornson in U.S. Pat. No. 4,631,971, the rotor will move in a hypercycloid path (clockwise) or trajectory in the frame of reference of the platform. 20. In position I at the 12:00 o'clock or Top Dead Center position the rotor 50 points in the direction of thrust T at maximum radius and rotational speed. At postion III the rotor 50 is centered on the sun gear 30 and is thus in a null position. As the rotor 50 moves clockwise, its motion is outbound generating strong coriolis forces tending also in the clockwise direction. At position IV, the coriolis forces of the rotor 50 as well as the planet gear mass 35 point generally upward, creating, with vectorial addtion of their centrifugal forces, the upward vertical thrust that lifts the system into the air (peaking at position I).

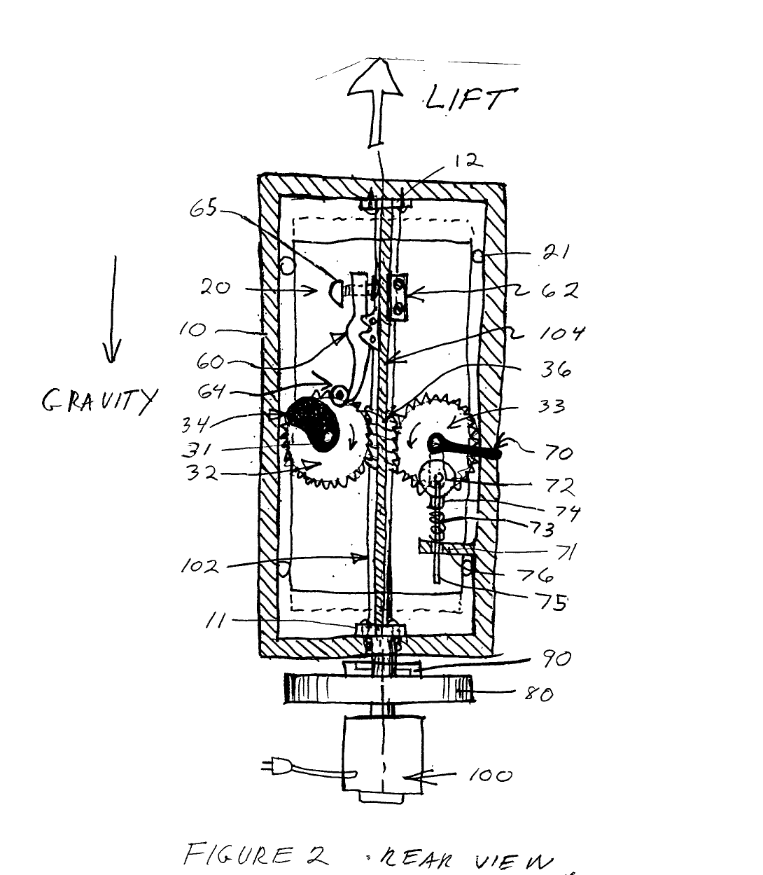

In FIG. 2, the rear view of the invention is shown with details of the control system for coupling and positioning the oscillator to the frame 10. The planet gear 35 is driven via axle 31 connected to worm gear 32 driven by helical worm 36 slideably mounted on spline shaft 102. The spine shaft 102 is connected to the clutch assembly 90, which engages the flywheel 80 and motor 100. The worm 36 is mounted on the platform 20 via endplates not shown. And adjustable cam 34 attached to the worm gear 32 axle is clocked to engage the follower 64 on the arm of a toggle clamp 60 or other suitable mechanical clutching device. The toggle clamp 60 grips a grooved load rod 104 that is fixed to the frame 10 at the top and bottom. A backplate 62 holds the rod 104 against the clamping force of the toggle adjustment bolt 65. The cam 34 is clocked to actuate the toggle clutch and thus engage the rod 104 when the upward acceleration of the platform 10 can lift the payload. At the end of this operation, not exceeding 90 degrees duration, the release pin 70 on the idler worm gear 33 is clocked to knock the toggle arm follower 64 thus releaseing the toggle clutch. Also on the idler worm gear 33 is a crank pin 72 with push rod 75 free to swivel at its top end about 72 pin. The compression spring 73 and adjustment sleeve 74 are set to push against the plate 76 attached to the frame 10 thru guide hole 71 for the push rod 75. This postioning system exerts a upward spring pulse with a peak value when the crank is in the most downward position as shown. The effect of the crank-spring mechanism, is to restore, for each cycle of thrust, the elevational position of the oscillator in the frame and maintain it operationally. In FIG. 2a, an oldham coupler is shown which can alternately be used to transmit torque to the rotor axle from a fixed motor and provide high torque capacity and zero backlash.

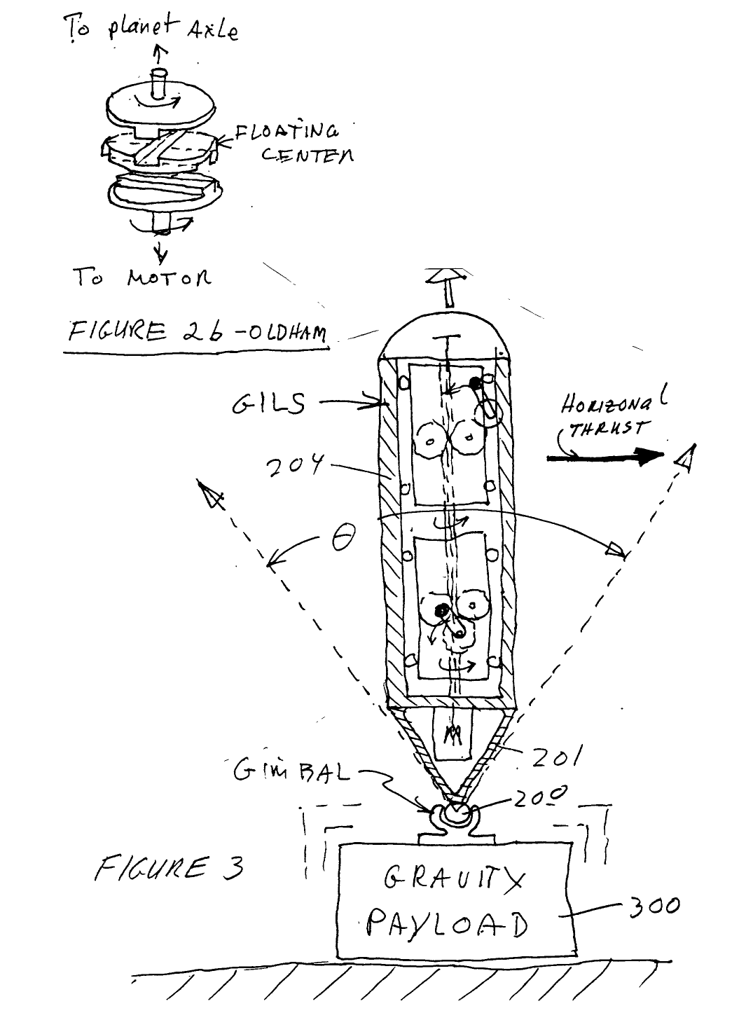

In FIG. 3, two units are shown each clocket 180 degrees appart in a common rigid frame with a gimbal truss 201 assembly on the bottom. The gimba 200 1 is attached to a heavy payload. Thus, the thrust assembly 204 may be vectored off from the vertical to generate horizonal thrust and lateral motion of the payload 300.

In operation, the thrust assembly 204 is vertically oriented with a heavy payload at the bottom. The motor is activated and the oscillator pair reciprocates up and down in the guide channel of the rigid frame 10. The spring crank mechanism maintains the location of the oscillators as the clutching system is activated by the cam 34. Pulses of thrust acting upward, and not exceeding 90 degrees of rotation of the planet gear 35 occur, and the payload is lifted off the ground. The amplitude of the platform is restricted and energy lessened. In the remaining 270 degrees, the oscillator is in free fall, and energy is restored to the rotors via the motor and spine shaft arrangement. Just before the start of clutching in the next cycle, the spring-crank restores the elevation position. This step engenders only a negligible amount of downward “recoil” force since the rotors have withdrawn to a much lower radius during this backstroke. The system may thus have application as in a warehouse for lifting heavy pallets or other stored material, reducing the friction with the floor, and with the lateral vectoring process, move the heavy load to the desired point.

I claim:

1. A coriolis inertial oscillator consisting of an orbiting mass with radial motion on a moveable platform, said mass rotating at a regulated constant angular velocity, from a motor-flywheel, via sliding rigid coupling, the platform constrained to move linearly in a vertical channel parallel to the earth's gravitational field, the channel housed in a rigid frame attached to a payload at the bottom, the oscillating channel is mechanically clutched to the frame via a member when the forces are upward and not exceeding 90 degrees in each rotation with repositioning of the platform from a spring-crank mechanism..

2. A system as claimed in 1., where the mechanical clutch is a toggle clamp engaging a grooved member held by a back plate,

3. A system as claimed in 1, where the mechanical clutch is a eccentric cam with lever arm engaging a grooved member with spring release

4. A system as claimed in 1 where the mechanical clutch is ball in an inclined plane with spring release of ball via slotted lever

5. A system as claimed in 1 where the mechanical clutch is a cam buckle acting on a nylon webbiing material member

6. A system as claimed in 1 where the rotor mass is a satellite mass fixed to a planet gear via arm which revolves around a fixed sun gear

7. As claimed in 4 where the distances between the rotor, planet and sun gear are equal

8. As claimed in 5 where the satellite mass is zero and the planet gear revolves about the sun with equal mass

9. A system as claimed in 1 where the platform mass is twice the weight of the combined planet gear and rotor

10. A system as claimed in 1. where the flywheel is replaced with a ball governor

11. A system as claimed in 1 where the motor is an induction motor with variable frequency speed control

12. A system as claimed in 1 where the motor is a rotary wankel engine

13. A system as claimed in 1 where the motor is a DC electric motor powered from a fuel cell.

14. A system as claimed in 1 where the slide coupler is a splined shaft with sliding worm engaging a worm gear set

15. A system as claimed in 1 where the slide coupler is an oldham coupler connecting the drive source with the oscillator axle

16. A system as claimed in 1 comprising multiple oscillators with at least two coaxially coupled by a common oldham coupler, each being clocked 180 degrees apart on independent platforms, driven by the motor oldham coupler

17. A system as claimed in 16 with four oscillators clocked 90 degrees appart, each indepenently oscillating from common oldham couple motor drive source.

18. A system as claimed in 16 where the spring-crank repositioning device is driven by a chain drive and sprocket arrangement off a sprocket of equal size rotatably connected to the oldham..
